(19) United States
(12) Patent Application Publication
(10) Pub. No.: US 2011/0090264 A1
(43) Pub. Date: Apr. 21, 2011

(54) IMPULSE-TYPE IMAGE DISPLAY APPARATUS AND METHOD FOR DRIVING THE SAME

(75) Inventor: Eisaku Tatsumi, Kawasaki-shi (JP)

(73) Assignee: CANON KABUSHIKI KAISHA, Tokyo (JP)

(21) Appl. No.: 12/920,858

(22) PCT Filed: Mar. 30, 2009
(86) PCT No.: PCT/JP2009/057014

§ 371 Date: Sep. 3, 2010

(30) Foreign Application Priority Data
Apr. 22, 2008 (JP) 2008-111518

(51) Int. Cl. G09G 5/10

(52) U.S. Cl. 345/690

(57) ABSTRACT

An impulse-type image display apparatus includes a frame frequency conversion circuit for converting an image signal of a first frame frequency into an image signal of a second frame frequency greater than the first frame frequency, a plurality of gradation conversion circuits for converting a gradation of the image signal of the second frame frequency, and a selection circuit for periodically selecting an output image from the plurality of the gradation conversion circuits. A gradation conversion ratio of at least one gradation conversion circuits of the plurality of gradation conversion circuits is different from the gradation conversion ratios of the other gradation conversion circuits.

### TECHNICAL FIELD

The present invention relates to an image display apparatus and a method for driving the image display apparatus. In particular, the present invention relates to an impulse-type image display apparatus such as a Cathode-Ray Tube (CRT) and Field Emission Display (FED) and a method for driving the impulse-type image display apparatus.

### BACKGROUND ART

Image display apparatuses can be classified as hold-type or impulse-type in terms of motion image display.

The hold-type image display apparatus continuously displays an image during one frame period. Known examples of hold-type image display apparatuses include a liquid-crystal display apparatus using TFTs and an organic electroluminescent display.

The impulse-type image display apparatus displays an image in pixels only a period during which the pixels are being scanned in one frame period. The luminance of the pixels decreases immediately after the scan. Known examples of impulse-type image display apparatuses include CRTs and FEDs.

The impulse-type image display apparatus has the advantage of high motion image visibility compared with the hold-type image display apparatus. However, the impulse-type image display apparatus can cause the problem of a flickering view called flicker.

Flicker is perceived when light stimuli of a square wave with a low frequency are observed. The perception of flicker decreases as the frequency is gradually increased. Finally the perception of flicker disappears. The frequency at which the perception of flicker disappears is called the Critical Fusion Frequency (CFF). It is known that light stimuli at frequencies greater than CFF are perceived as light having intensity equal to time-averaged luminance (Talbot-Plateau Law). It is also known that CFF is proportional to the logarithm of mean luminance of an object (Ferry-Porter Law). It is also known that CFF is proportional to the logarithm of the area of an object (Granit-Harper Law). From these facts, it can be said that flicker is more likely to be perceived at a lower frame frequency, higher luminance, and in a larger display area.

Frame frequencies in the range from 50 to 60 Hz are used in practice because the annoyance of flicker can be reduced to a sufficiently low level. In today's large, high-brightness displays, however, flicker can be perceived even at these frequencies.

A technique is known that simply displays a video frame with a frequency of 60 Hz twice as a video image at 120 Hz in order to reduce flicker to a barely perceivable level.

Japanese Patent Application Laid-Open No. H06-070288 discloses a technique that doubles a frame frequency and eliminates high-frequency components of images.

It has been found that as the frame frequency is increased in order to reduce flicker of an impulse-type image display apparatus to a barely perceivable level, the brightness, vividness, impressiveness, texture, and three-dimensional appearance, which are advantages of impulse-type display apparatuses, degrade.

An object of the present invention is to provide an image display apparatus in which flicker is barely perceivable and degradation in quality such as brightness of an image is minimized and a method for driving the image display apparatus.

### DISCLOSURE OF THE INVENTION

An impulse-type image display apparatus includes: a frame frequency conversion circuit for converting an image signal of a first frame frequency into an image signal of a second frame frequency greater than the first frame frequency; a plurality of gradation conversion circuits for converting a gradation of the image signal of the second frame frequency; and a selection circuit for periodically selecting an output image from the plurality of the gradation conversion circuits; wherein a gradation conversion ratio of at least one gradation conversion circuit of the plurality of gradation conversion circuits is different from gradation conversion ratios of the other gradation conversion circuits.

The impulse-type image display apparatus further includes: a plurality of gradation conversion circuits for converting a gradation of an image signal whose frame frequency is greater than or equal to 75 Hz; and a selection circuit for periodically selecting an output image of the plurality of gradation conversion circuits; wherein a gradation conversion ratio of at least one gradation conversion circuit of the plurality of gradation conversion circuits is different from gradation conversion ratios of the other gradation conversion circuits.

A method for driving an impulse-type image display apparatus includes: converting an image signal of a first frame frequency into an image signal of a second frame frequency greater than the first frame frequency; and periodically converting a gradation of the image signal of the second frame frequency with a different gradation conversion ratio.

A method for driving an impulse-type image display apparatus includes periodically converting a gradation of an image signal whose frame frequency is greater than or equal to 75 Hz using different gradation conversion ratios.

The term “frame frequency” as used herein refers to the number of images (frames) displayed per second in progressive scanning or the number of images (fields) displayed per second in interlace scanning.

According to the present invention, flicker can be reduced to a barely perceivable level and degradation in brightness can be minimized.

Further features of the present invention will become apparent from the following description of exemplary embodiments with reference to the attached drawings.

### BRIEF DESCRIPTION OF THE DRAWINGS

FIGS. 1A and 1B are diagrams illustrating an experiment on the effect of blink light stimuli on apparent brightness perception and the result of the experiment.

FIG. 2 is a schematic diagram illustrating a vision system.

FIG. 3 is a schematic diagram of a wave of condensation and rarefaction in an optic nerve.

FIG. 4 is a diagram illustrating the relationship between the number of pulses of a wave of condensation and rarefaction in the primary visual center and image processing interval.

FIGS. 5A, 5B and 5C are diagrams illustrating the relationship between frequency and conversion ratio in a first embodiment.

FIG. 6 is a schematic diagram illustrating display images displayed according to the first embodiment.

FIG. 7 is a diagram illustrating a circuit configuration according to the first embodiment.

FIG. 8 is a diagram illustrating one example of a method for creating an interpolation frame image.

FIG. 9 is a diagram illustrating a function of a gradation conversion circuit according to the first embodiment.

FIG. 10 is a diagram illustrating a function of a gradation conversion circuit according to a second embodiment.

FIG. 11 is a diagram illustrating a function of a gradation conversion circuit according to a third embodiment.

FIGS. 12A, 12B and 12C are diagrams illustrating the relationship between frequency and conversion ratio in a fifth embodiment.

FIG. 13 is a diagram illustrating a configuration adjusting a gradation conversion ratio according to a seventh embodiment.

### BEST MODES OF CARRYING OUT THE INVENTION

Preferred embodiments of the present invention will now be described in detail in accordance with the accompanying drawings.

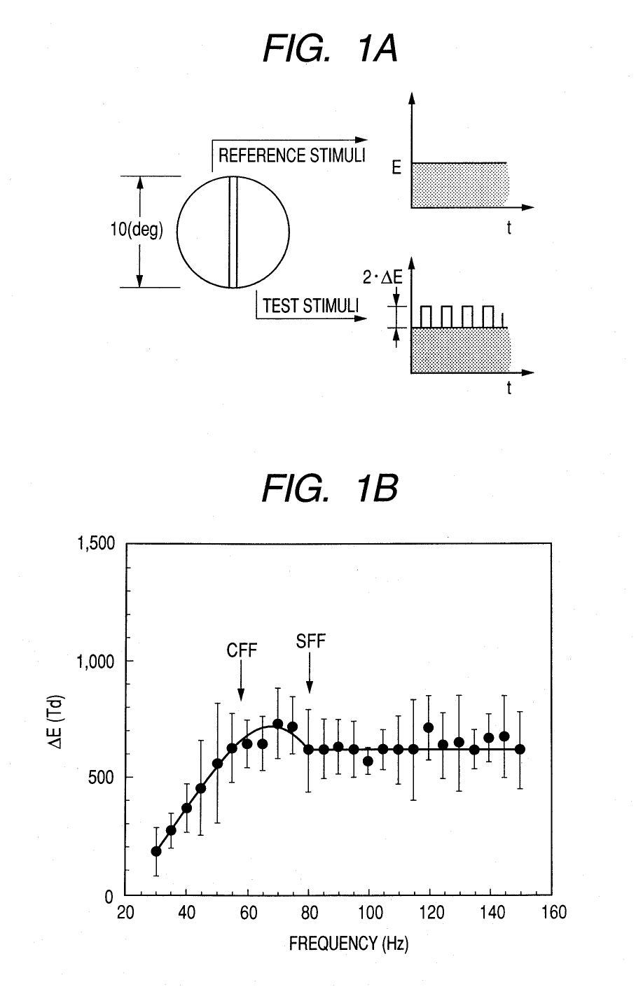

It is known that there are blink frequencies at which blink light stimuli are not apparently perceived as flickering but affect apparent brightness perception. Under a stimulus condition as shown in FIG. 1A, another light stimulus was applied and luminance determination thresholds for constant light and blink light were measured. FIG. 1B shows the measurements. At lower blink frequencies, the blink light appears brighter than the constant light and the threshold luminance is lower. However, near the CFF, the blink light appears less stable and the threshold increases. When the blink frequency is further increased, the threshold becomes approximately equal to that of the constant light. The blink frequency at which blink light display appears the same as constant light display is called SFF (Stable Fusion Frequency). It is known that SFF is greater than CFF.

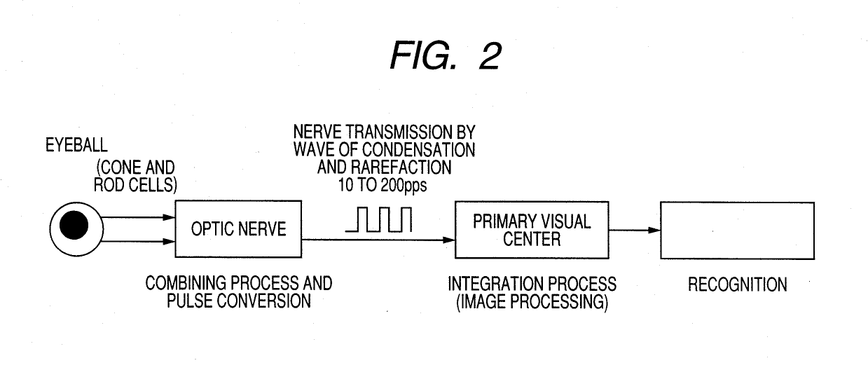

The fact that CFF and SFF differ from each other indicates that they come from different biologic reactions. This will be described with reference to FIG. 2, which schematically illustrates the vision system.

First, in the optic nerve that transfers a signal from the retina to the primary visual center, the signal is transferred as a wave of condensation and rarefaction. It is known that the primary visual center integrates signals arrived in an interval to perform image processing. Both of the pulse intervals of the wave of condensation and rarefaction and the image processing intervals in the visual center are constants relating to frequencies. The constants determine the upper-limit frequency at which a signal is transmitted. The frequency of the wave of condensation and rarefaction is higher than that of the image processing intervals in the visual center. Accordingly, it is considered that the pulse intervals of the wave of condensation and rarefaction in the optic nerve determine the SFF and the image processing intervals in the visual center determine the CFF.

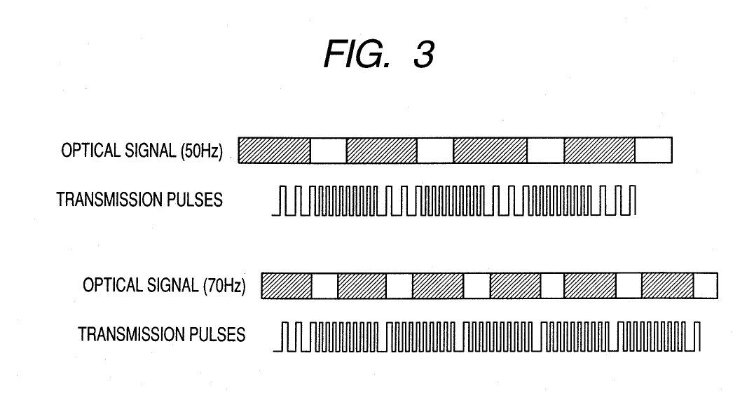

The relationship between wave of condensation and rarefaction in the optic nerve and SFF will be described next. FIG. 3 schematically shows a wave of condensation and rarefaction in the optic nerve. It can be seen that the wave of condensation and rarefaction of the transmission pulse of a 70-Hz optical signal is uniform compared with that of the transmission pulse of a 50-Hz optical signal. Thus, it is considered that as the frequency of an optical signal increases, the degree of uniformity of the wave of condensation and rarefaction becomes gradually increases and, at a frequency equivalent to SFF, the wave becomes almost completely uniform.

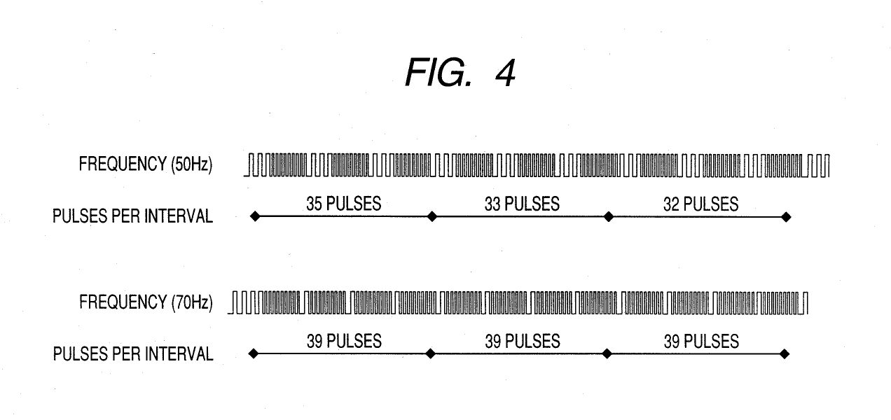

Interaction between the number of pulses of the wave of condensation and rarefaction and the image processing intervals in the primary visual center will be described with reference to FIG. 4.

As described above, the number of pulses of the wave of condensation and rarefaction varies with the frequency of an optical signal. In the example shown in FIG. 4, the image processing intervals are approximately 20 Hz.

In the example shown, the number of transmission pulses per image processing interval for a 50-Hz optical signal varies from 35 to 33 to 32. On the other hand, in the case of a 70-Hz optical signal, the number of transmission pulses per image processing interval remains the same, 39. In this way, the number of transmission pulses per image processing interval for a frequency of 50 Hz varies like a beat whereas the number of transmission pulses for 70 Hz does not vary.

Image processing intervals vary among individuals. When the frequency of the optical signal is 60 Hz, those who with short intervals perceive a beat whereas those who with longer intervals do not. Image processing intervals also vary depending on luminance. It is known that that the interval is shorter at a higher luminance and is longer at a lower luminance. Therefore, at an optical signal frequency of 60 Hz, a beat becomes perceivable as the luminance increases and the interval decreases and the beat becomes unperceivable as the luminance decreases and the interval increases. This agrees with the experimental result that CFF, which is the frequency at which flicker is perceived, varies with luminance.

Therefore, a beat is unperceivable at frequencies between CFF and SFF because the frequencies are greater than or equal to CFF. However, because the frequencies are lower than or equal to SFF, the light stimulus passes though the optic nerve to the primary visual center and a variation in the light stimuli can affect image processing in the primary visual center. It can be considered that the effect on the image processing in the primary visual center affects the vividness, three-dimensional appearance, and brightness.

It may be contemplated that an image with 60 Hz, for example, is converted to a frame frequency (for example 72 Hz) between CFF and SFF in order to minimize visibility of flicker and reduction in brightness of the image. However, the implementation increases the load of generating frame interpolation images, and increases the proportion of frame interpolation images in a series of frames to degrade the image quality.

Based on the fact that degradation in brightness is caused by the biological effects described above, the present invention displays an image that is equivalent to an image with a frame frequency between CFF and SFF by using a unit that does not directly converts the frame frequency of the image to a frequency between CFF and SFF. In particular, a frame frequency is converted to a frame frequency that can be readily generated, such as a frame frequency greater than the original frame frequency by a factor of N or 1.5, rather than slightly changing the frame frequency so as to fall within the range between CFF and SFF. After the conversion, the contrast of the frame is adjusted. This provides the same optical effect as that of lowering the frequency N times or 1.5 times greater to a frequency between CFF and SFF.

A specific configuration of an image display apparatus according to the present invention will be described below.

### First Embodiment

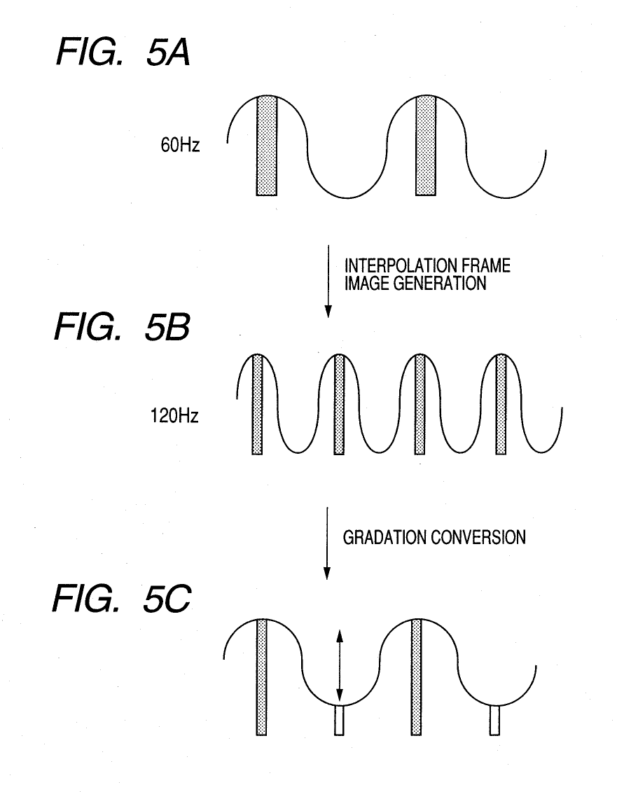

FIGS. 5A to 5C are schematic diagrams illustrating the relationship between frequency and gradation conversion ratio in the first embodiment of the present invention. The horizontal axis represents time and the vertical axis represents luminance.

FIG. 5A illustrates a case where an image with a frame frequency of 60 Hz is simply impulse-driven. FIG. 5B illustrates a case where an interpolation frame image is generated and is impulse-driven at a frame frequency (120 Hz) twice as high as that of the original image. FIG. 5C illustrates a case where gradation conversion is applied to the images to change the luminance of the interpolation frame image to a luminance different from that of the original frame image and impulse driving is applied.

The present embodiment will be described with respect to an example in which a frame frequency is doubled. However, the present invention is not limited to this. A frame frequency can be readily converted to a frequency that is an integral multiple, or a half-integral multiple greater than 1.

In the present embodiment, the frame frequency of an original image that is lower than or equal to CFF is converted to a frame frequency greater than or equal to SFF. As has been described, CFF and SFF vary among individuals and depend on luminance. In the present embodiment, frame frequency conversion is performed with the assumption that CFF is 65 Hz and SFF is 75 Hz.

Then, gradation conversion is performed and impulse driving is performed so that the luminance of the original frame image and the luminance of an interpolation frame image periodically alternate as shown in FIG. 5C.

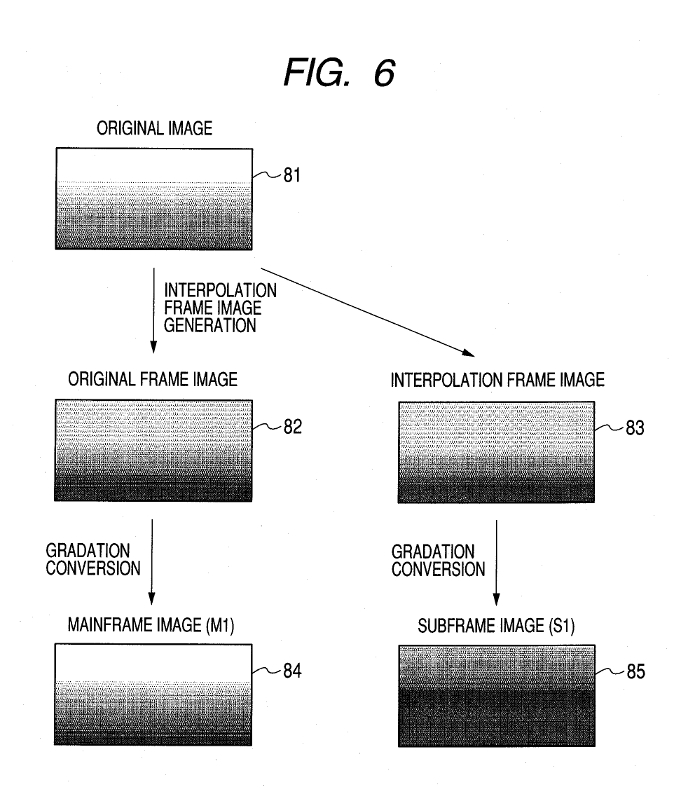

FIG. 6 is a schematic diagram illustrating display images displayed according to the present embodiment.

From an original image 81, an original frame image 82 and an interpolation frame image 83, each with half the luminance of the original image, are generated. The luminances of original frame image 82 and the interpolation frame image 83 are then changed by gradation conversion to generate a bright main frame image (M1) 84 and a dark sub frame image (S1) 85.

When the number of gradation levels of the main frame image and the number of gradation levels of the sub frame image are added together to obtain the same number of gradation levels as that of the original image, the number of gradation levels of the main frame image will be greater than or equal to the half the number of the gradation levels of the original image and that of the sub frame image will be less than or equal to the half the number of gradation levels of the original image.

The luminance of the image after gradation conversion does not necessarily need to be the same as that of the original image. The image after gradation conversion may be made brighter or darker than the original image. The gamma characteristic also may be change.

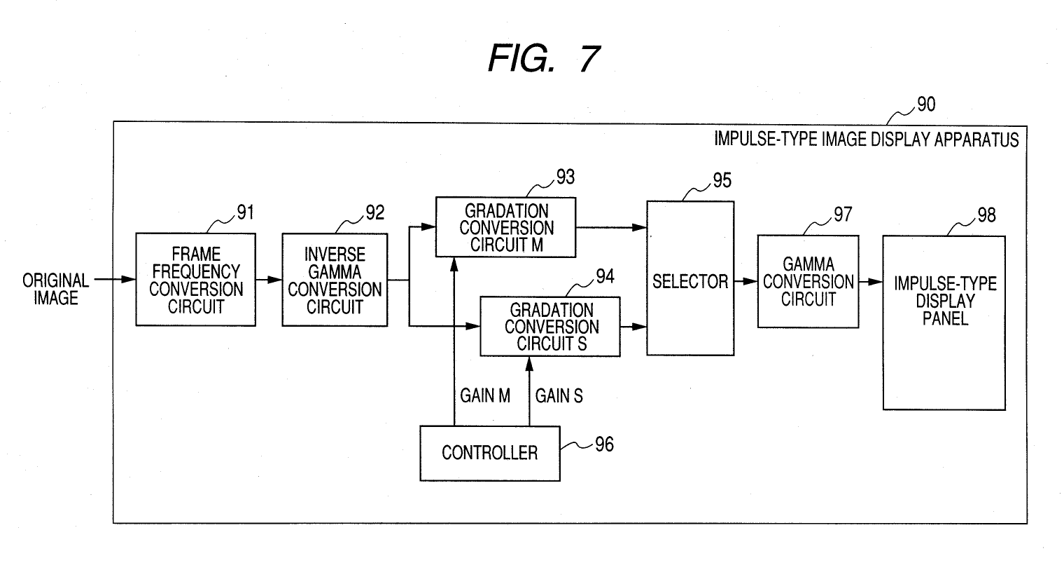

A circuit configuration of driving circuitry according to the present embodiment will be described with reference to FIG. 7.

As shown, a frame frequency conversion circuit 91 and an inverse gamma conversion circuit 92 are provided. Inverse gamma conversion of the gradation of an image converts the gamma image to a linear image, thereby facilitating computation of gradation. Gradation conversion circuits 93 and 94 are provided. In particular, the gradation conversion circuit 93 (“first gradation conversion circuit” of the present invention) is used for converting main frame gradation and the gradation conversion circuit 94 (“second gradation conversion circuit” of the present invention) is used for converting sub frame gradation. A selector (“selection circuit” of the present invention) 95 selects between an output image of the main frame gradation conversion circuit 93 and an output image of the sub frame gradation conversion circuit 94. In the present embodiment, the selector 95 alternately selects one of an output of the main frame gradation conversion circuit 93 and an output of the sub frame gradation conversion circuit 94. A controller 96 sets a gain or a gain table for the gradation conversion circuits 93 and 94. An output from a gamma conversion circuit 97 is input into an impulse-type display panel 98. These components constitute an impulse-type image display apparatus 90.

The frame frequency conversion circuit 91 will be described below in further detail.

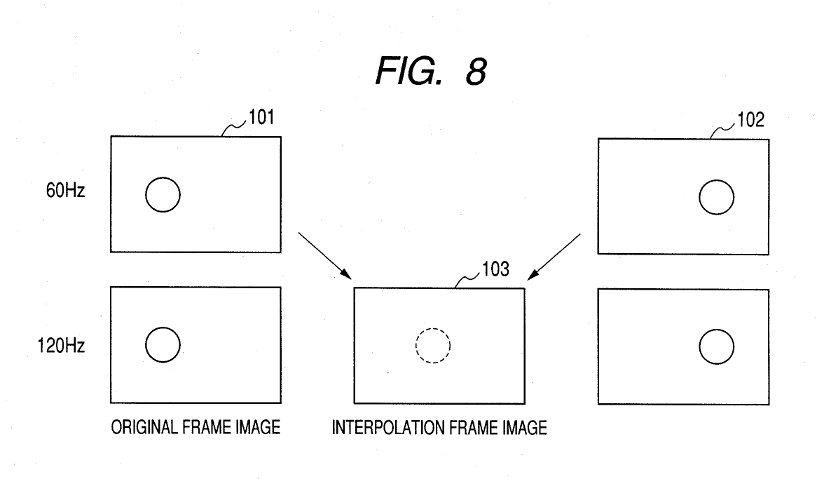

An original image from a video input apparatus such as a tuner is input in the frame frequency conversion circuit 91. In the present embodiment, the frame frequency of the original image is 60 Hz. The frame frequency of the original image represents a first frame frequency of the present invention. The frame frequency conversion circuit 91 converts the original image to an image of a higher frequency. In the present embodiment, the frame frequency conversion circuit 91 converts the frame frequency to 120 Hz. The converted frame frequency represents a second frame frequency of the present invention. Thus, the converted frame frequency becomes greater than SFF (75 Hz). As has been described with respect to FIG. 6, the luminance of each of the frequency-converted original frame image 82 and interpolation frame image 83 may be reduced to half the luminance of the original image. However, displaying the same image twice can result in a double-line interference called motion blur. Therefore, a motion vector can be detected from a frame image 101 of the original image and the next frame 102 and an interpolation frame image 103 may be generated as shown in FIG. 8. The interpolation frame image 103 can be generated by a known technique such as motion vector detection.

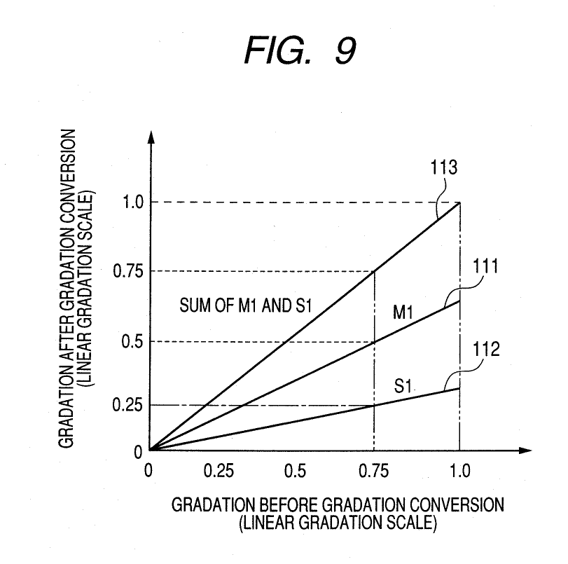

FIG. 9 illustrates gradation conversation accomplished by the gradation conversion circuits 93 and 94 of the present embodiment. The horizontal axis represents gradation before gradation conversion and the vertical axis represents gradation after gradation conversion. Gradation 1.0 is the highest gradation and gradation 0 is the lowest gradation. The ratio of gradation after gradation conversion to gradation before gradation conversion is referred to as the gradation conversion ratio.

Straight line plot 111 in FIG. 9 determines the gradation conversion ratio (“first gradation conversion ratio” of the present invention) for a main frame image (M1). Straight line plot 112 determines the gradation conversion ratio (“second gradation conversion ratio” of the present invention) for a sub frame image (S1). Straight line plot 113 represents the sum of the main frame image (M1) and the sub frame image (S1). As can be seen from the graph, in the present embodiment, the gradation conversion ratio of the sub frame image is constant with respect to the gradation conversion ratio of the main frame image independently of gradation.

The luminance of the original image and the luminance after gradation conversion can be made equal by determining the gradation conversion ratios 111 and 112 such that the plot 113 representing the sum of the main frame image (M1) and the sub frame image (S1) becomes a straight line at an angle of 45 degrees. If the luminance after gradation conversion does not need to be made equal to the luminance of the original image, the plot 113 representing the sum of the main frame image (M1) and the sub frame image (S1) does not need to be a straight line at an angle of 45 degrees.

In the present embodiment, the gradation conversion ratio of the main frame image (M1) is the two thirds and the gradation conversion ratio of the sub frame image (S1) is the one third.

The gradation conversion ratios of the main frame image (M1) and the sub frame image (S1) need to meet the following conditions.

A first condition is that the ratio between the luminance of the main frame image and the luminance of the sub frame image should not be so large that flicker is strongly perceived when the main frame image and the sub frame image are alternately displayed. To meet the condition, the luminance of the main frame image need to be no greater than four times the luminance of the sub frame image.

A second condition is that the luminance ratio should not be so small that brightness is degraded when the main frame image and the sub frame image are alternately displayed. To meet the condition, the luminance of the main frame image need to be at least 1.5 times the luminance of the sub frame image.

The luminance of the main frame image will be four times the luminance of the sub frame image when the luminance ratio between the main frame image and the sub frame image is 4:1. The luminance of the main frame image is 1.5 times the luminance of the sub frame image when the luminance ratio between the main frame image and the sub frame image is 3:2. This translates into the condition that the luminance of the sub frame image should be greater than or equal to 25% and less than or equal to 67% of the luminance of the main frame image.

The image subjected to the gradation conversion as described above was displayed on the impulse-type image display apparatus. It has been shown that, even though the image was displayed with 120 Hz, brightness, vividness, texture, and three-dimensional appearance equivalent to those of images displayed with 60 Hz can be perceived.

### Second Embodiment

The second embodiment differs from the first embodiment in the characteristics of gradation conversion circuits 93 and 94. The rest is the same as the first embodiment.

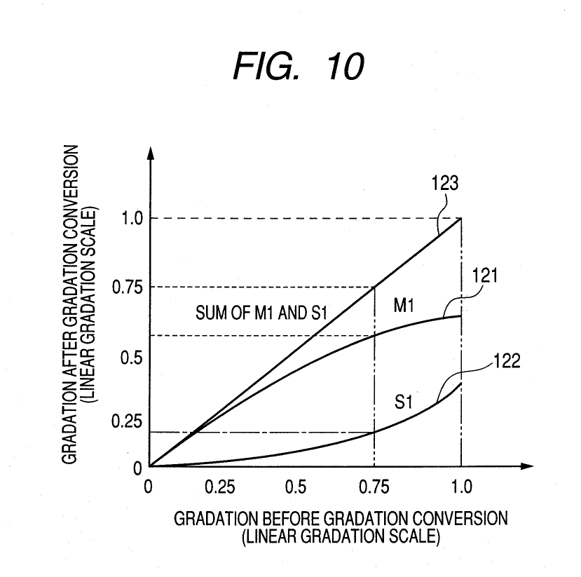

FIG. 10 illustrates gradation conversion accomplished by the gradation conversion circuits 93 and 94 of the second embodiment.

Curve 121 in FIG. 10 represents gradation conversation ratio for a main frame image (M1), curve 122 represents gradation conversion ratio for a sub frame image (S1), and straight line 123 represents the sum of the main frame image and the sub frame image.

The luminance of the original image and the luminance after gradation conversion can be made equal by determining the gradation conversion ratios 121 and 122 such that the plot 123 representing the sum of the main frame image (M1) and the sub frame image (S1) becomes a straight line at an angle of 45 degrees. If the luminance after gradation conversion does not need to be made equal to the luminance of the original image, the plot 123 representing the sum of the main frame image (M1) and the sub frame image (S1) does not need to be a straight line at an angle of 45 degrees.

In the present embodiment, the rate of the gradation conversion ratio of the sub frame image (S1) with respect to the gradation conversion ratio of the main frame image (M1) is small in a low gradation region. In a high gradation region, on the other hand, the rate of the gradation conversion ratio of the sub frame image (S1) with respect to the gradation conversion ratio of the main frame image (M1) is large.

The characteristic of the gradation conversion ratios according to the second embodiment allows the display in a low gradation region in which flicker is barely perceived to approximate the display in which only the main frame image is displayed. Thus, the image quality is improved. In a high gradation region in which flicker is more likely to be perceived, the luminance of the sub frame image is made closer to the luminance of the main frame image so that flicker is barely perceivable.

### Third Embodiment

The third embodiment differs from the embodiments described above in that the inverse gamma conversion circuit and the gamma conversion circuit are omitted and that gradation conversion circuits 93 and 94 have characteristics different from the embodiments described above. The rest of the third embodiment is the same as the embodiments described above.

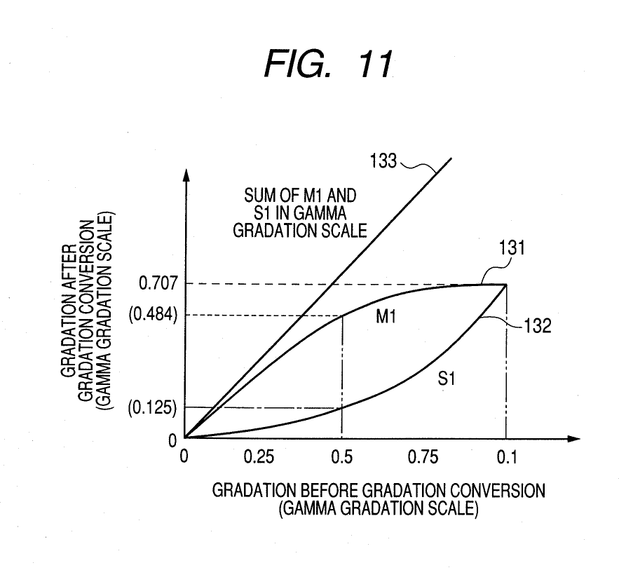

FIG. 11 illustrates gradation conversion accomplished by the gradation conversion circuits 93 and 94 of the third embodiment.

Curve 131 in FIG. 11 represents a gradation conversion ratio for a main frame image (M1), curve 132 represents a gradation conversion ratio for a sub frame image (S1), and straight line 133 represents the sum of the main frame image and the sub frame image. The horizontal axis represents gradation before gradation conversion and the vertical axis represents gradation after gradation conversion. Both of the vertical and horizontal axes represent gamma gradation scales.

The gamma gradation conversion enables the inverse gamma conversion circuit 92 and the gamma conversion circuit 97 to be omitted.

### Fourth Embodiment

In the fourth embodiment, an original frame image 82 (“original image signal” of the present invention) is generated from one image signal with 60 Hz before frame frequency conversion. In addition, an interpolation frame image 83 (“interpolation image signal” of the present invention) is generated from two image signals with 60 Hz before frame frequency conversion. A known technique such as motion vector detection can be used to generate the interpolation frame image.

In the fourth embodiment, the gradation conversion ratio of the original frame image is higher than the gradation conversion ratio of the interpolation frame image.

Consequently, the luminance of the interpolation frame image, which is lower in image quality than the original frame image, is reduced and therefore the quality of the entire image can be improved.

### Fifth Embodiment

The embodiments above have been described with respect to implementations in which two gradation conversion circuits are provided, as an example in which multiple gradation conversion circuits are provided. However, the present invention is not limited to the configuration. The present invention can also be applied to a configuration in which three or more gradation conversion circuits are provided. The fifth embodiment will be described in which five gradation conversion circuits are provided.

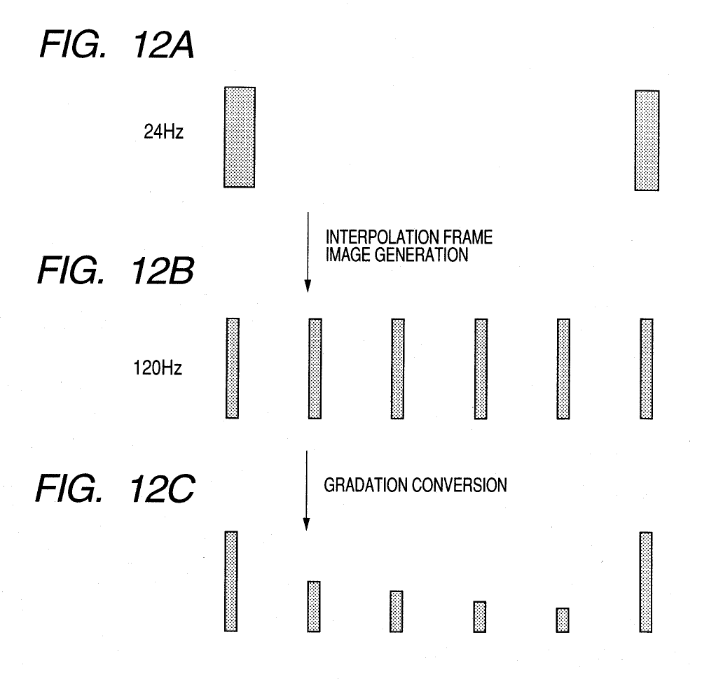

FIGS. 12A to 12C are schematic diagrams illustrating the relationship between frequency and gradation conversion ratio in the fifth embodiment. The horizontal axis represents time and the vertical axis represents luminance.

FIG. 12A illustrates a case where a 24P image is extracted from a 60I or 50I image that is a broadcast video signal converted from a 24P image such as a motion picture by 2:3 pull-down and is simply impulse-driven with 24P. Motion in this display is smooth but, when the luminance is increased, strong flicker occurs because of low frequency. This method is suitable for display in a dark theater room with a luminance of 40 Cd/m² or less.

FIG. 12B illustrates a case where an image is displayed with 120P in order to prevent flicker from being perceived in normal living-room lighting. To generate a 120P image from a 24P image, the same image is displayed five times. As a result, unclearness is caused by motion and vividness, three-dimensional appearance, and brightness are lost.

In the fifth embodiment, gradation conversion as shown in FIG. 12C is performed to gradually reduce the luminance while the same image was displayed five times.

As a result, unclearness caused by motion can be reduced while at the same time vividness, three-dimensional appearance, and brightness can be maintained.

In a specific circuit configuration, five gradation conversion circuits with different gradation conversion ratios may be provided and a selector may periodically select among the five gradation conversion circuits in order of decreasing gradation conversion ratio.

Although the same image is displayed five times while decreasing the luminance in the present embodiment, not all of the five gradation conversion circuits need to have different gradation conversion ratio characteristics. For example, four of the five gradation conversion circuits may have the same gradation conversion characteristic.

### Sixth Embodiment

The above embodiments have been described with respect to an example in which a 60-Hz original image is converted to a 120-Hz image by a frame frequency conversion circuit. However, the present invention is not limited to such a configuration. The present invention can be applied to an original image with a frame frequency greater than or equal to SFF, such as 120 Hz. In that case, the frame frequency conversion circuit described above is not required.

According to the present embodiment, improved brightness, vividness, texture, and three-dimensional appearance can be perceived as compared with those of a 120-Hz original image simply displayed without the conversion.

### Seventh Embodiment

The seventh embodiment allows a user to adjust the gradation conversion ratio of a gradation conversion circuit.

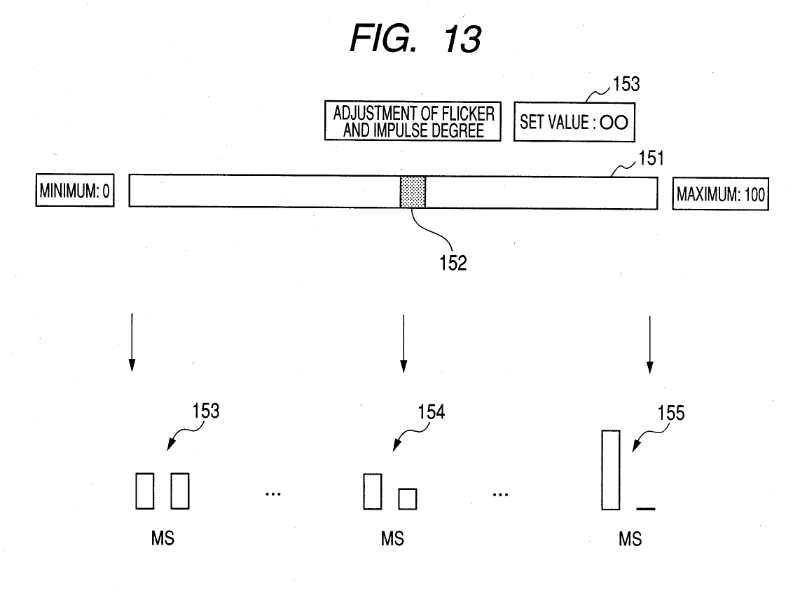

FIG. 13 is a schematic diagram illustrating the correspondence between screen objects and gradation conversion ratios. As shown, an adjustment bar graph 151 is provided that can be controlled with a control unit such as a remote control. Also provided is a cursor 152 indicating the current set value. The set value indicated by the cursor position is displayed 153 and the value determines the gradation conversion ratios. For example, if the set value is 0, the gradation conversion ratios are M:S=1:1 as shown 153. If the set value is 50, the gradation conversion ratios are M:S=2:1 as shown 154. If set value is 100, the gradation conversion ratios are M:S=1:0 as shown 155. A value in the range between 0 and 100 can be linearly set. Here, M denotes the gradation conversion ratio of a main frame image and S denotes the gradation conversion ratio of a sub frame image. The user may be allowed to set the gradation conversion ratio of the main frame image to any value in the range between 50% and 100% and the gradation conversion ratio of the sub frame image to any value in the range between 0% and 50%.

Another configuration is also preferable in which, instead of allowing a viewer to adjust a set value as described above, selectable modes such as “vivid mode” and “movie mode” may be provided. In this case, display luminance and therefore the visibility of flicker vary among the modes. Gradation conversion ratios are determined beforehand for each mode so that different gradation conversion ratios are set by selecting a different mode.

Since the configuration allows a viewer to adjust the gradation conversion ratios as described above, those who are not sensitive to flicker can choose to display a bright image by increasing the difference between the gradation conversion ratio of the main frame image and the gradation conversion ratio of the sub frame image. On the other hand, viewers who are sensitive to flicker can decrease the difference between the gradation conversion ratio of the main frame image and the gradation conversion ratio of the sub frame image to reduce flicker to a barely perceivable level.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-111518, filed Apr. 22, 2008, which is hereby incorporated by reference herein in its entirety.

1. An impulse-type image display apparatus comprising:
a frame frequency conversion circuit for converting an image signal of a first frame frequency into an image signal of a second frame frequency, the second frame frequency being greater than the first frame frequency;
a first gradation conversion circuit for converting a gradation of the image signal of the second frame frequency with a first gradation conversion ratio which is greater than zero and less than one;
a second gradation conversion circuit for converting a gradation of the image signal of the second frame frequency with a second gradation conversion ratio which is greater than zero and less than said first gradation conversion ratio; and
a selection circuit for alternately selecting output image signals from the first gradation conversion, circuit and the second gradation conversion circuit.

2. The impulse-type image display apparatus according to claim 1, wherein
the image signal of the second frame frequency comprises an original image signal created from one image signal of the first frame frequency and an interpolation image signal created from a plurality of image signals of the first frame frequency, and
the gradation of the original image signal is converted with the first gradation conversion ratio and the gradation of the interpolation image signal is converted with the second gradation conversion ratio.

3. The impulse-type image display apparatus according to claim 1, wherein the number of gradation levels of the output image signal from the first gradation conversion circuit and the number of gradation levels of the output image signal from the second gradation conversion circuit are added together to obtain the same number of gradation levels as the image signal of the first frame frequency.

4. The impulse-type image display apparatus according to claim 1, wherein
the second gradation conversion ratio with respect to the first gradation conversion ratio is constant independently of the gradation of the image signal of the second frame frequency.

5. The impulse-type image display apparatus according to claim 1, wherein
the first gradation conversion ratio that is a gradation conversion ratio of the first gradation conversion circuit is greater than the second gradation conversion ratio that is a gradation conversion ratio of the second gradation conversion circuit, and a rate of the second gradation conversion ratio with respect to the first gradation conversion ratio when the image signal of the second frame frequency is a first gradation is less than a rate of the second gradation conversion ratio with respect to the first gradation conversion ratio when the image signal of the second frame frequency is a second gradation greater than the first gradation.

6. The impulse-type image display apparatus according to claim 1, wherein the rate of the second gradation conversion ratio with respect to the first gradation conversion ratio ranges from 25% to 67%.

7. The impulse-type image display apparatus according to one of claim 1, wherein the second frame frequency is greater than or equal to 75 Hz.

8. The impulse-type image display apparatus comprising:
a frame frequency conversion circuit for converting an image signal of a first frame frequency into an image signal of a second frame frequency, the second frame frequency being greater than the first frame frequency;
a gradation conversion circuit for converting a gradation of an image signal of the second frame frequency with at least two different gradation conversion ratios which are greater than zero and less than one; and
a selection circuit for alternately selecting at least two different output image signals converted with said at least two different gradation conversion ratios.

9. The impulse-type image display apparatus according to claim 1, further comprising:
an adjustment means for adjusting the gradation conversion ratio of the gradation conversion circuit.

10. A method for driving an impulse-type image display apparatus, comprising the steps of:
converting an image signal of a first frame frequency into an image signal of a second frame frequency, the second frame frequency being greater than the first frame frequency;
converting a gradation of the image signal of the second frame frequency with a first gradation conversion ratio which is greater than zero and less than one, and converting the gradation of the image signal of the second frequency with a second gradation conversion ratio which is greater than zero and less than said first gradation conversion ratio; and
selecting alternately image signals converted with the first gradation conversion ratio and the second gradation conversion ratio.

11. The method for driving the impulse-type image display apparatus according to claim 10, wherein
the step of converting the frame frequency includes creating an original signal from one image signal of the first frame frequency and creating an interpolation image signal from a plurality of image signals of the first frame frequency, and
the gradation of the original image signal is converted with the first gradation conversion ratio and the gradation of the interpolation image signal is converted with the second gradation conversion ratio.

12. The method for driving the impulse-type image display apparatus according to claim 10, wherein
the number of gradation levels of the image signal converted with the first gradation conversion ratio and the number of gradation levels of the image signal converted with the second gradation conversion ratio are added together to obtain the same number of gradation levels as the image signal of the first frame frequency.

13. The method for driving the impulse-type image display apparatus according to claim 10, wherein
the second frame frequency is greater than or equal to 75 Hz.

14. A method for driving an impulse-type image display apparatus, wherein the rate of the second gradation conversion ratio with respect to the first gradation conversion ratio ranges from 25% to 67%.

15. The impulse-type image display apparatus according to claim 8, further comprising:
an adjustment means for adjusting the gradation conversion ratio of the gradation conversion circuit.
